(19) United States
(12) Patent Application Publication
(10) Pub. No.: US 2023/0122673 A1
(43) Pub. Date: Apr. 20, 2023

(54) DATA GENERATION METHOD, DECISION METHOD, PROGRAM, AND DATA GENERATION SYSTEM

(71) Applicant: Panasonic Intellectual Property Management Co., Ltd., Osaka (JP)

(72) Inventors: Junko ONOZAKI, Hokkaido (JP); Koji OBATA, Osaka (JP); Hisashi AIKAWA, Osaka (JP); Yuya SUGASAWA, Osaka (JP)

(21) Appl. No.: 17/911,614

(22) PCT Filed: Mar. 9, 2021
(86) PCT No.: PCT/JP2021/009324

§ 371 Date: Sep. 14, 2022

(30) Foreign Application Priority Data
Mar. 25, 2020 (JP) 2020-055048

(51) Int. Cl. G06N 20/00

(52) U.S. Cl. CPC G06N 20/00

(57) ABSTRACT

A data generation method includes a first acquisition step, a second acquisition step, and a generation step. The first acquisition step includes acquiring result information about a result of a classification executed by a living being on a target. The second acquisition step includes acquiring execution information about execution of the classification. The generation step includes generating data for machine learning based on the result information and the execution information. The data for machine learning includes learning data and evaluation information about evaluation of the learning data.

### TECHNICAL FIELD

The present disclosure generally relates to a data generation method, a decision method, a program, and a data generation system. More particularly, the present disclosure relates to a data generation method for generating learning data, a decision method that uses the learning data, a program designed to perform the data generation method and the decision method, and a data generation system for generating the learning data.

### BACKGROUND ART

Patent Literature 1 discloses an information processing device (data generation system) for generating learning data for use in machine learning. The information processing device of Patent Literature 1 includes an input interface, a decider, a manager, a setter, and a generator. The input interface receives time series data entered. The decider determines a starting point and an end point of a particular event with respect to the time series data and thereby generates decision result information indicating the starting point and the end point. The manager manages accuracy information indicating the degree of accuracy of the decision result information. The setter sets an adjustment width according to the degree of accuracy indicated by the accuracy information such that the higher the degree of accuracy is, the shorter the adjustment width is and the lower the degree of accuracy is, the longer the adjustment width is. The generator generates learning data for use in machine learning by attaching a label indicating whether a particular event has occurred or not to time series data between the starting point and the end point that have been adjusted according to the adjustment width.

### CITATION LIST

### Patent Literature

Patent Literature 1: JP 2019-160013 A

### SUMMARY OF INVENTION

Machine learning sometimes requires a varying degree of accuracy for learning data according to the stage of learning. Patent Literature 1 does not take the evaluation of the learning data itself into account.

The problem is to provide a data generation method, a decision method, a program, and a data generation system, all of which contribute to improving the accuracy of classification based on a learned model.

A data generation method according to an aspect of the present disclosure includes a first acquisition step, a second acquisition step, and a generation step. The first acquisition step includes acquiring result information about a result of a classification executed by a living being on a target. The second acquisition step includes acquiring execution information about execution of the classification. The generation step includes generating data for machine learning based on the result information and the execution information. The data for machine learning includes learning data and evaluation information about evaluation of the learning data.

A decision method according to another aspect of the present disclosure includes executing a classification of the target using a learned model. The learned model has been generated by machine learning using the learning data of the data for machine learning that has been generated by the data generation method described above.

A program according to still another aspect of the present disclosure is designed to cause one or more processors to perform the data generation method described above.

A program according to yet another aspect of the present disclosure is designed to cause one or more processors to perform the decision method described above.

A data generation system according to yet another aspect of the present disclosure includes a first acquirer, a second acquirer, and a generator. The first acquirer acquires result information about a result of a classification executed by a living being on a target. The second acquirer acquires execution information about execution of the classification. The generator generates data for machine learning based on the result information and the execution information. The data for machine learning includes learning data and evaluation information about evaluation of the learning data.

### BRIEF DESCRIPTION OF DRAWINGS

FIG. 1 schematically illustrates a data generation method according to an exemplary embodiment;

FIG. 2 is a flowchart of the data generation method;

FIG. 3 is a block diagram of a data generation system that performs the data generation method;

FIG. 4 illustrates data for machine learning obtained by the data generation method; and

FIG. 5 is a block diagram of a decision system that uses a learned model based on the learning data of data for machine learning that has been generated by the data generation method.

### DESCRIPTION OF EMBODIMENTS

### (1) Embodiment

### (1.1) Overview

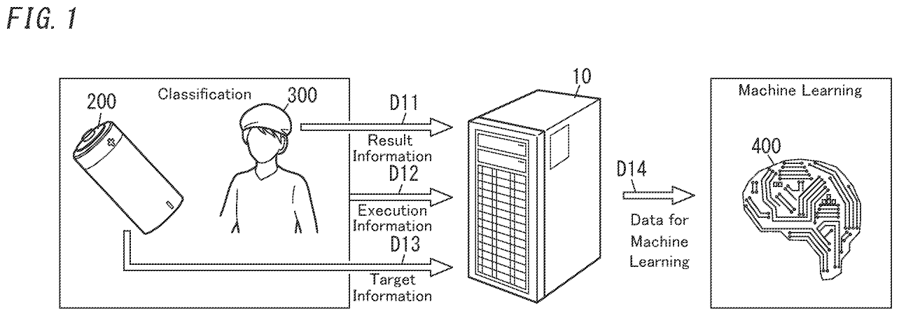

FIG. 1 schematically illustrates a data generation method according to an exemplary embodiment. The data generation method according to this embodiment is used to generate data (hereinafter referred to as “data D14 for machine learning”) for making a machine learning program (model or algorithm) 400 learn the classification executed by a living being 300 on a target 200.

As used herein, the target 200 is a target (which may be a tangible object or an intangible object, whichever is appropriate) of a classification to be executed by the living being 300. In this embodiment, the target 200 is an electric cell. The electric cell is an example of the target 200. Alternatively, the target 200 may also be a tangible such as a product, agricultural produce, a marine product, a natural thing, a living thing, or an astral body or only a part, not all, of a tangible object (such as a human body's skin). Examples of the products include electrical equipment such as lighting fixtures and air conditioners, vehicles such as automobiles, watercrafts, aircrafts, medicines, and foods. Examples of the agricultural produce include fruits, cereals, and flowers. Furthermore, the target 200 does not have to be a tangible object itself but may also be an image of the tangible object. Furthermore, the target 200 does not have to be visual information such as an image but may also be auditory information such as a sound, olfactory information such as an odor, gustatory information such as a taste, or tactile information such as thermal sensations.

The living being 300 is an agent that executes a classification of the target 200. In this embodiment, the living being 300 is a human being. The human being is an example of the living being 300. Alternatively, the living being 300 may also be a non-human creature such as an animal, fungi, or a plant. For example, the target 200 may also be classified by using a rat as an animal or by using bacteria. Thus, these may also be adopted as the living beings 300.

In this embodiment, the classification executed by the living being 300 on the target 200 refers to the classification executed visually by the living being 300 on the target 200 into a normal product or a defective product. The classification may be executed in any of various manners depending on the target 200 and the living being 300. For example, if the target 200 is a sound and the living being 300 is a human being, then the human being listens to the sound as the target 200 and classifies the target 200 into a normal sound or an abnormal sound.

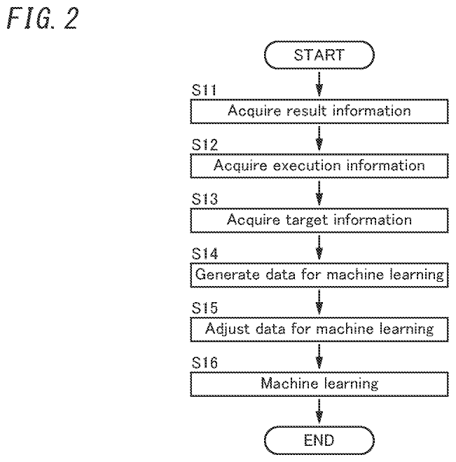

A data generation method according to this embodiment includes a first acquisition step S11, a second acquisition step S12, and a generation step S14 as shown in FIG. 2.

The first acquisition step S11 includes acquiring result information D11 about the result of the classification executed by the living being 300 on the target 200. The second acquisition step S12 includes acquiring execution information D12 about the execution of the classification. The generation step S14 includes generating data D14 for machine learning based on the result information D11 and the execution information D12. The data D14 for machine learning includes learning data and evaluation information about the evaluation of the learning data.

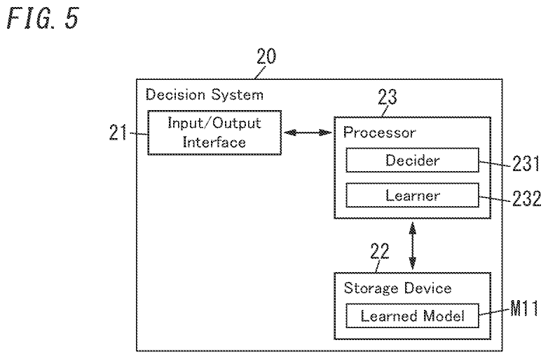

The data generation method according to this embodiment includes acquiring not only the result information D11 but also the execution information D12 as well, thereby generating data D14 for machine learning including learning data and evaluation information about the evaluation of the learning data. That is to say, in the data generation method according to this embodiment, not only learning data but also evaluation information about the evaluation of the learning data are generated as well. This enables sorting, by evaluation, the learning data suitable for machine learning to be carried out or selectively using only highly evaluated learning data. Thus, the data generation method according to this embodiment achieves the advantage of contributing to improving the accuracy of classification based on the learned model M11 (see FIG. 5).

### (1.2) Details

Next, the data generation method according to this embodiment will be described in further detail with reference to FIGS. 1-4. As described above, the data generation method according to this embodiment is used to generate data (data D14 for machine learning) for causing the machine learning model 400 to learn the classification executed by the living being 300 on the target 200.

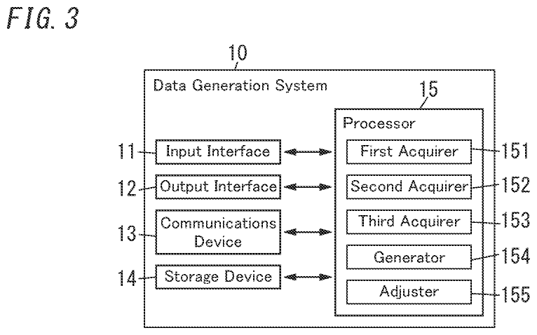

The data generation method according to this embodiment is performed by the system (data generation system) 10 shown in FIGS. 1 and 3.

The data generation system 10 includes an input interface 11, an output interface 12, a communications device 13, a storage device 14, and a processor 15.

The input interface 11, the output interface 12, and the communications device 13 together form an input/output interface through which data is input to, and output from, the data generation system 10. Through the input/output interface, the result information D11, the execution information D12, and the target information D13 may be input to the data generation system 10. Through the input/output interface, the data D14 for machine learning may be output from the data generation system 10.

The input interface 11 may include an input device for operating the data generation system 10. The input device includes, for example, a touch pad and/or one or more buttons. The output interface 12 may include an image display device for displaying information thereon. The image display device is a thin display device such as a liquid crystal display or an organic electroluminescent (EL) display. Optionally, a touchscreen panel may be formed by the touch pad of the input interface 11 and the image display device of the output interface 12. The communications device 13 may include a communications interface and may be used to input the result information D11, the execution information D12, and the target information D13 and output the data D14 for machine learning therethrough by either wired communication or wireless communication. Note that the communications device 13 is not an essential constituent element.

The storage device 14 is used to store information to be used by the processor 15. Examples of the information to be used by the processor 15 include the result information D11, the execution information D12, and the target information D13. The storage device 14 includes one or more storage devices, which may be, for example, a random-access memory (RAM) and/or an electrically erasable programmable read-only memory (EEPROM).

The processor 15 is a control circuit for controlling the operation of the data generation system 10. The processor 15 may be implemented as a computer system including one or more processors (microprocessors) and one or more memories. That is to say, the functions of the processor 15 are performed by making the one or more processors execute one or more programs (applications) stored in the one or more memories. In this embodiment, the program is stored in advance in the one or more memories of the processor 15. However, this is only an example and should not be construed as limiting. The program may also be downloaded via a telecommunications line such as the Internet or distributed after having been stored in a non-transitory storage medium such as a memory card.

As shown in FIG. 3, the processor 15 includes a first acquirer 151, a second acquirer 152, a third acquirer 153, a generator 154, and an adjuster 155. Note that the first acquirer 151, the second acquirer 152, the third acquirer 153, the generator 154, and the adjuster 155 shown in FIG. 3 do not have a substantive configuration but just represent respective functions to be performed by the processor 15.

The first acquirer 151 acquires the result information D11. The result information D11 is information about the result of the classification executed by the living being 300 on the target 200. In this embodiment, the result information D11 indicates the result of the classification executed by the living being 300 on the target 200. Also, in this embodiment, the classification to be executed by the living being 300 on the target 200 is supposed to be the classification to be executed by the living being 300 that is a human being on the target 200 that is an electric cell into a normal product and a defective product. In this case, the human being 300 may be a person who inspects the electric cell 200. Note that the “target” and the “living being” will be hereinafter sometimes paraphrased as an “electric cell” and a “person,” respectively, to make the following description more easily understandable. For example, the first acquirer 151 makes the image display device of the output interface 12 present an image of the electric cell 200 and makes the input interface 11 accept the result of the classification executed by the person 300 on the electric cell 200. This enables acquiring the result information D11.

The second acquirer 152 acquires the execution information D12. The execution information D12 is information about the execution of the classification by the living being 300 on the target 200. The execution information D12 is used to evaluate the result of the classification executed by the living being 300 on the target 200. The evaluation of the classification result may be an index to the degree of reliability of the classification result. That is to say, the execution information D12 is used to learn about the degree of accuracy (i.e., the degree of reliability) of the classification result. The execution information D12 may include time information. The time information is information about the time (decision time) it has taken for the living being (person) 300 to have the classification done. For example, the time information may include the decision time itself. The decision time may be, for example, the time it has taken for the person 300 to enter the classification result into the input interface 11 since the person 300 recognized an image of the electric cell 200 presented on the output interface 12. The longer the time it has taken for the living being 300 to have the classification done, the lower the degree of accuracy of the classification result would be. Stated otherwise, the shorter the time it has taken for the living being 300 to have the classification done, the higher the degree of accuracy of the classification result would be. Thus, the decision time may be used to evaluate the classification result.

The third acquirer 153 acquires the target information D13. The target information D13 is information about the target 200. The target information D13 includes information about the target 200 presented to the living being 300 while the target 200 is being classified by the living being 300.

The generator 154 generates the data D14 for machine learning based on the result information D11, the execution information D12, and the target information D13. The data D14 for machine learning includes learning data and evaluation information.

The learning data is data that may be used to generate a learned model Ml 1 (see FIG. 5) by machine learning. In this embodiment, the learning data is data representing correspondence between the target information D13 and the result information D11. That is to say, the learning data is data for supervised learning. In this case, the target information D13 (i.e., information about the target 200) is data about the target of classification and the result information D11 (i.e., the classification result) is a label. The learning data is used to make a supervised machine learning algorithm 400 learn the correspondence between the target 200 and the classification result and thereby generate the learned model M11. The learning data is classified, according to the intended use, into supervisor data (training data), development data, and test data (inspection data). In this embodiment, the learning data may be any one of the supervisor data (training data), development data, or test data (inspection data).

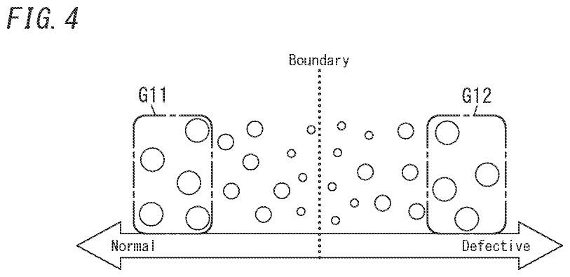

The evaluation information is information about the evaluation of the learning data. The evaluation of the learning data includes evaluation about the degree of accuracy (i.e., degree of reliability) of the learning data. In this embodiment, the degree of accuracy (i.e., degree of reliability) of the learning data corresponds to the degree of accuracy (i.e., degree of reliability) of the classification result. The evaluation information is generated based on the result information D11 and the execution information D12. More specifically, the generator 154 obtains, based on the result information D11 and the execution information D12, an evaluation value indicating the degree of accuracy of the learning data. As described above, the execution information D12 may include the time information. The generator 154 uses the decision time derived from the time information to determine the evaluation value indicating the degree of accuracy of the learning data. For example, the generator 154 determines the evaluation value to be a value falling within the range from 0 to 100. If the result information D11 indicates that the target 200 is a normal product, the generator 154 determines the evaluation value to be a value falling within the range from 0 to 50 and decreases the evaluation value as the decision time shortens. On the other hand, if the result information D11 indicates that the target 200 is an abnormal product, the generator 154 determines the evaluation value to be a value falling within the range from 51 to 100 and increases the evaluation value as the decision time shortens. As a result, a distribution of learning data such as the one shown in FIG. 4 is obtained. FIG. 4 conceptually illustrates the evaluation values as open circles. In FIG. 4, “normal” indicates a normal product, “defective” indicates an abnormal product, and “boundary” indicates the boundary between “normal” and “defective.” Also, in FIG. 4, the larger the open circle is, the higher the degree of accuracy of the classification result is. That is to say, the evaluation is made such that the more distant from the boundary an evaluation value is, the higher the degree of accuracy of the evaluation value is. In this embodiment, the generator 154 uses the result information D11 and the execution information D12 to generate the evaluation values. This makes the evaluation value thus generated a value indicating the decision result of the classification and its degree of accuracy (i.e., degree of reliability) comprehensively. Note that the relationship between the decision time and the evaluation value does not have to be linear but may also be curved and may be set as appropriate.

The adjuster 155 removes learning data, of which the evaluation information fails to meet the standard, from the data D14 for machine learning. The standard may be determined depending on what type of learning data needs to be obtained. For example, the standard may indicate a decision value with respect to the evaluation value. The standard may be set, for example, to determine whether the evaluation value falls within the range defined by the decision value. In this embodiment, the evaluation value is determined to fall within the range from 0 to 100. If the evaluation value falls within the range from 0 to 50, the classification result is a normal product. On the other hand, if the evaluation value falls within the range from 51 to 100, the classification result is an abnormal product. If the classification result is a normal product, the smaller the evaluation value is, the higher the degree of accuracy is. On the other hand, if the classification result is an abnormal product, the larger the evaluation value is, the higher the degree of accuracy is. Thus, if highly accurate learning data needs to be obtained irrespective of the classification result, then the standard may be set such that the evaluation value is either equal to or less than 5 or equal to or greater than 95. In this manner, learning data corresponding to an evaluation value that falls within the range designated by either G11 or G12 in FIG. 4 is obtained. If the classification result is a normal product and highly accurate learning data needs to be obtained, then the standard may be set such that the evaluation value is equal to or less than 5. If the classification result is an abnormal product and highly accurate learning data needs to be obtained, then the standard may be set such that the evaluation value is equal to or greater than 95. If learning data with a low degree of accuracy needs to be obtained irrespective of the classification result, then the standard may be set such that the evaluation value is equal to or greater than 45 and equal to or less than 55. If the classification result is a normal product and learning data with a low degree of accuracy needs to be obtained, then the standard may be set such that the evaluation value is equal to or greater than 45 and equal to or less than 50. If the classification result is an abnormal product and learning data with a low degree of accuracy needs to be obtained, then the standard may be set such that the evaluation value is equal to or greater than 51 and equal to or less than 55. As can be seen, the classification result and the degree of accuracy of the learning data obtained from the data generation system 10 may be set by appropriately setting the standard. In machine learning, the degree of accuracy required for the learning data sometimes varies according to the stage of learning. This adjuster 155 enables automatically sorting the learning data in response to the request. Optionally, the standard to be used by the adjuster 155 may be entered into the data generation system 10 via the input interface 11.

### (1.3) Operation

Next, the data generation method performed by the data generation system 10 will be described briefly with reference to the flowchart shown in FIG. 2. Note that the flowchart shown in FIG. 2 is only an example and the respective processing steps of the data generation method are not always performed in the order shown in the flowchart of FIG. 2.

According to this data generation method, the first acquirer 151 acquires the result information D11 about the result of the classification executed by the living being 300 on the target 200 (in S11). The second acquirer 152 acquires the execution information D12 about the execution of the classification (in S12). The third acquirer 153 acquires the target information D13 about the target 200 (in S13). The generator 154 generates data D14 for machine learning based on the result information D11, the execution information D12, and the target information D13 (in S14). The data D14 for machine learning includes learning data and evaluation information about the evaluation of the learning data. The adjuster 155 removes learning data, of which the evaluation information fails to meet the standard, from the data D14 for machine learning (in S15). The data D14 for machine learning thus obtained by this data generation method is used for machine learning, thereby generating a learned model M11 (in S16).

### (1.4) Application Example

Next, it will be described how to use the data D14 for machine learning generated by the data generation system 10. FIG. 5 illustrates a decision system 20 that uses the learned model Ml 1 generated based on the data D14 for machine learning.

The decision system 20 includes an input/output interface 21, a storage device 22, and a processor 23.

The input/output interface 21 is an interface serving as both an input interface through which an image of the target 200 is input and an output interface through which the classification result of the target 200 is output. The input/output interface 21 may include an input device for operating the decision system 20. The input device includes, for example, a touch pad and/or one or more buttons. The input/output interface 21 may also include an image display device for displaying information thereon. The image display device is a thin display device such as a liquid crystal display or an organic electroluminescent (EL) display. Optionally, a touchscreen panel may be formed by the touch pad and the image display device of the input/output interface 21. The input/output interface 21 may further include a communications interface and may be used to input an image for evaluation of the sample and output the evaluation result by either wired communication or wireless communication.

The storage device 22 stores the learned model M11 that is a decision model for use to classify the target 200. The learned model M11 is a learned model that has learned the relationship between the image of the target 200 (i.e., the target information D13) and the classification result (i.e., the result information D11) of the target 200 based on the learning data of the data D14 for machine learning that has been generated by the data generation method (data generation system 10) described above. The learned model 11l is generated by a learner 232 to be described later. The storage device 22 includes one or more storage devices. The storage devices may be a RAM and/or an EEPROM.

The processor 23 is a control circuit for controlling the operation of the decision system 20. The processor 23 may be implemented as a computer system including one or more processors (microprocessors) and one or more memories. That is to say, the functions of the processor 23 are performed by making the one or more processors execute one or more programs (applications) stored in the one or more memories. In this embodiment, the program is stored in advance in the one or more memories of the processor 23. However, this is only an example and should not be construed as limiting. The program may also be downloaded via a telecommunications line such as the Internet or distributed after having been stored in a non-transitory storage medium such as a memory card.

As shown in FIG. 5, the processor 23 includes a decider 231 and a learner 232. In FIG. 5, the decider 231 and the learner 232 do not have substantive configurations but just represent functions to be performed by the processor 23.

The decider 231 is in charge of a so-called “inference phase.” The decider 231 classifies, by using the learned model Ml 1 stored in the storage device 22, the target 200 based on the image of the target 200 received at the input interface (input/output interface 21). On receiving the image of the target 200 via the input/output interface 21, the decider 231 enters the image of the target 200 thus received into the learned model M11 and has the classification result of the target 200 output. On obtaining the classification result of the target 200, the decider 231 has the result displayed by the input/output interface 21.

The learner 232 generates the learned model M11 as described above. That is to say, the learner 232 is in charge of the learning phase. The learner 232 collects and accumulates learning data for generating the learned model M11. The learning data is derived from the data D14 for machine learning in the data generation system 10. The learner 232 generates a learned model Ml 1 based on the learning data thus collected. That is to say, the learner 232 makes an artificial intelligence program (algorithm) 400 learn the relationship between the image of the target 200 and the classification result based on the learning data of the data D14 for machine learning that has been generated by the data generation system 10. The artificial intelligence program 400 is a machine learning program. For example, a neural network, which is a type of hierarchical model, may be used as the artificial intelligence program 400. The learner 232 generates the learned model M11 by making the neural network perform machine learning (such as deep learning) using a learning data set. Optionally, the learner 232 may attempt to improve the performance of the learned model Ml 1 by performing re-learning using the learning data that has been newly collected.

### (1.5) Recapitulation

The data generation system 10 described above includes a first acquirer 151, a second acquirer 152, and a generator 154. The first acquirer 151 acquires result information D11 about a result of a classification executed by a living being 300 on a target 200. The second acquirer 152 acquires execution information D12 about execution of the classification. The generator 154 generates data D14 for machine learning based on the result information D11 and the execution information D12. The data D14 for machine learning includes learning data and evaluation information about evaluation of the learning data. This data generation system 10 contributes to improving the accuracy of classification based on a learned model M11.

In other words, it can be said that the data generation system 10 performs the method (data generation method) shown in FIG. 2. The data generation method includes a first acquisition step S11, a second acquisition step S12, and a generation step S14. The first acquisition step S11 includes acquiring result information D11 about a result of a classification executed by a living being 300 on a target 200. The second acquisition step S12 includes acquiring execution information D12 about execution of the classification. The generation step S14 includes generating data D14 for machine learning based on the result information D11 and the execution information D12. The data D14 for machine learning includes learning data and evaluation information about evaluation of the learning data. This data generation method, as well as the data generation system 10, contributes to improving the accuracy of classification based on the learned model M11.

The data generation system 10 is implemented by using a computer system. That is to say, the method performed by the data generation system 10 (i.e., the data generation method) may be carried out by making the computer system execute a program. This program is a computer program designed to cause one or more processors to perform the data generation method. Such a program, as well as the data generation system 10, contributes to improving the accuracy of classification based on the learned model M11.

The decision system 20 described above executes classification of the target 200 using a learned model M11. The learned model M11 has been generated by machine learning using the learning data of the data D14 for machine learning that has been generated by the data generation method described above. This decision system 20 contributes to improving the accuracy of classification based on the learned model M11.

In other words, it can be said that the decision system 20 performs the following method (decision method). The decision method includes executing a classification of the target 200 using a learned model M11. The learned model M11 has been generated by machine learning using the learning data of the data D14 for machine learning that has been generated by the data generation method described above. This decision method, as well as the decision system 20, contributes to improving the accuracy of classification based on the learned model M11.

The decision system 20 is implemented by using a computer system. That is to say, the method performed by the decision system 20 (i.e., the decision method) may be carried out by making the computer system execute a program. This program is a computer program designed to cause one or more processors to perform the decision method. Such a program, as well as the decision system 20, contributes to improving the accuracy of classification based on the learned model M11.

### (2) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Next, variations of the exemplary embodiment will be enumerated one after another.

In one variation, the execution information D12 may include condition information. The condition information is information about the living being's (person's) 300 condition. More specifically, the condition information is information about the living being's (person's) 300 subjective condition. The living being's (person's) 300 condition may affect the result of the classification to be executed by the living being 300 on the target 200. For example, even the same person may make a difference in the classification result depending on whether he or she is in a good physical condition or not. Thus, the living being's (person's) 300 condition may be used to evaluate the classification result. The living being's 300 condition includes at least one of the living being's 300 mental and physical conditions. Examples of the living being's 300 mental condition include his or her degree of concentration, physical shape, and emotions. Examples of the living being's 300 physical condition include his or her degree of fatigue, age, eyesight, hearing, and reflexes. The condition information may be acquired by using various types of sensors (such as a pulse sensor and an image sensor). For example, the degree of fatigue may be acquired based on the living being's (person's) 300 facial expression obtained from an image sensor. For instance, the generator 154 may determine a final evaluation value by adding a correction value based on the condition information to an evaluation value that has been determined based on the time information.

In another variation, the execution information D12 may include subjective information. The subjective information is information about the living being's 300 subjective opinion on the classification. Examples of the living being's 300 subjective opinion on the classification may include the living being's 300 subjective opinion on the degree of self-confidence in the classification result, the living being's 300 subjective opinion on the degree of difficulty of the classification result, and the living being's 300 subjective opinion on his or her own condition. The living being's 300 subjective opinions such as these may be used to evaluate the classification results. For example, if the person 300 has an opinion that his or her degree of self-confidence is low or the degree of difficulty is high, then the degree of accuracy of the classification result would be low. Conversely, if the person 300 has an opinion that his or her degree of self-confidence is high or the degree of difficulty is low, then the degree of accuracy of the classification result would be high. The living being's 300 subjective condition, as well as the condition information, may be reflected on the evaluation information. For example, the generator 154 may determine a final evaluation value by adding a correction value based on the subjective information to an evaluation value that has been determined based on the time information.

In another variation, the result information D11 may include results of classifications executed by a plurality of living beings 300. The execution information D12 may include relative information about the respective classifications executed by a plurality of the living beings 300. The relative information may be information for performing standardization to make the respective degrees of accuracy of the classifications executed by multiple different living beings 300 comparable to each other. The relative information may have its weight defined, for example, with the living being's 300 proficiency in classification taken into account. This makes it easier to integrate results of classifications executed by multiple different living beings 300 into a single set of learning data. This facilitates increasing the number of populations of the learning data, thus eventually contributing to improving the degree of accuracy of the learned model M11.

In another variation, the execution information D12 may include statistical information. The statistical information includes information about statistics of the results of classifications executed by a plurality of the living beings 300 on the target 200. That is to say, the statistical information may be information indicating the statistics of the result information D11 obtained by multiple different living beings 300 with respect to the same target 200. For example, the classification result and its degree of accuracy may be determined based on the statistics of the results of classifications executed by multiple different living beings 300 on the same target 200. If the distribution of the classification results indicates that the number of the living beings 300 who have found the target 200 normal is larger than the number of the living beings 300 who have found the target 200 defective, then the classification result may be that the target 200 should be regarded, by majority vote, as a normal product and the degree of accuracy of the classification result may be determined based on the difference between the number of the living beings 300 who have found the target 200 normal and the number of the living beings 300 who have found the target 200 defective. That is to say, it can be said that using the statistical information means evaluating the classification result by majority rule.

In another variation, the execution information D12 may include at least one of time information, condition information, relative information, statistical information, and subjective information. The execution information D12 may include all of the time information, condition information, relative information, statistical information, and subjective information. That is to say, the evaluation information may be determined as appropriate by integrating pieces of information included in the execution information D12.

In another variation, the generator 154 does not have to use the result information D11 when generating the evaluation information. Alternatively, the generator 154 may generate the evaluation information based on the execution information D12. For example, the generator 154 may determine the evaluation value based on the decision time of the time information derived from the execution information D12.

In another variation, the target information D13 may be included in the result information D11. In that case, the data generation system 10 does not have to include the third acquirer 153.

In another variation, the data generation system 10 does not have to include the adjuster 155.

In the embodiment described above, the data generation system 10 includes the input interface 11, the output interface 12, the communications device 13, and the storage device 14. In another variation, the input interface 11, the output interface 12, the communications device 13, and the storage device 14 may be provided for a system outside of the data generation system 10. In other words, the input interface 11, the output interface 12, the communications device 13, and the storage device 14 are not essential constituent elements for the data generation system 10.

In another variation, either the data generation system 10 or the decision system 20 may be implemented as a plurality of computers. For example, the functions (in particular, the first acquirer 151, the second acquirer 152, and the generator 154) of the data generation system 10 may be distributed in a plurality of devices. Likewise, the functions (in particular, the decider 231) of the decision system 20 may also be distributed in a plurality of devices. Furthermore, at least some functions of the data generation system 10 or the decision system 20 may be implemented as a cloud computing system, for example.

The agent that performs the functions of the data generation system 10 or decision system 20 described above includes a computer system. The computer system includes a processor and a memory as hardware components. The agent may perform the functions of the data generation system 10 or decision system 20 according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be implemented as a single or a plurality of electronic circuits including a semiconductor integrated circuit (IC) or a large-scale integrated circuit (LSI). Optionally, a field-programmable gate array (FPGA) to be programmed after an LSI has been fabricated or a reconfigurable logic device allowing the connections or circuit sections inside of an LSI to be reconfigured may also be used for the same purpose. Those electronic circuits may be either integrated together on a single chip or distributed on multiple chips, whichever is appropriate. Those multiple chips may be aggregated together in a single device or distributed in multiple devices without limitation.

### (3) Aspects

As can be seen from the foregoing description of embodiments and their variations, the present disclosure has the following aspects. In the following description, reference signs are inserted in parentheses just for the sake of clarifying correspondence in constituent elements between the following aspects of the present disclosure and the exemplary embodiments described above.

A first aspect is a data generation method, which includes a first acquisition step (S11), a second acquisition step (S12), and a generation step (S14). The first acquisition step (S11) includes acquiring result information (D11) about a result of a classification executed by a living being (300) on a target (200). The second acquisition step (S12) includes acquiring execution information (D12) about execution of the classification. The generation step (S14) includes generating data (D14) for machine learning based on the result information (D11) and the execution information (D12). The data (D14) for machine learning includes learning data and evaluation information about evaluation of the learning data. This aspect contributes to improving the accuracy of classification based on a learned model (M11).

A second aspect is a data generation method which may be implemented in conjunction with the first aspect. In the second aspect, the evaluation information includes an evaluation value indicating a degree of accuracy of the learning data. This aspect enables sorting the learning data by the degree of accuracy.

A third aspect is a data generation method which may be implemented in conjunction with the first or second aspect. In the third aspect, the learning data is data representing correspondence between target information (D13) about the target (200) and the result information (D11). This aspect enables generating data (D14) for machine learning suitable for supervised learning.

A fourth aspect is a data generation method which may be implemented in conjunction with any one of the first to third aspects. In the fourth aspect, the learning data includes supervisor data. This aspect enables performing training during the process of generating the learned model (M11).

A fifth aspect is a data generation method which may be implemented in conjunction with any one of the first to fourth aspects. In the fifth aspect, the execution information (D12) includes time information about a time it has taken for the living being (300) to have the classification done. This aspect contributes to improving the accuracy of the evaluation information.

A sixth aspect is a data generation method which may be implemented in conjunction with any one of the first to fifth aspects. In the sixth aspect, the execution information (D12) includes condition information about a condition of the living being (300). This aspect contributes to improving the accuracy of the evaluation information.

A seventh aspect is a data generation method which may be implemented in conjunction with the sixth aspect. In the seventh aspect, the condition of the living being (300) includes at least one of mental and physical conditions of the living being (300). This aspect contributes to improving the accuracy of the evaluation information.

An eighth aspect is a data generation method which may be implemented in conjunction with any one of the first to seventh aspects. In the eighth aspect, the result information (D11) includes results of classifications executed by a plurality of the living beings (300). The execution information (D12) includes relative information about the respective classifications executed by the plurality of the living beings (300). This aspect contributes to improving the accuracy of the evaluation information.

A ninth aspect is a data generation method which may be implemented in conjunction with any one of the first to eighth aspects. In the ninth aspect, the execution information (D12) includes statistical information about statistics of the results of classifications executed by a plurality of the living beings (300) on the target (200). This aspect contributes to improving the accuracy of the evaluation information.

A tenth aspect is a data generation method which may be implemented in conjunction with any one of the first to ninth aspects. In the tenth aspect, the execution information (D12) includes subjective information about a subjective opinion of the living being (300) on the classification. This aspect contributes to improving the accuracy of the evaluation information.

An eleventh aspect is a data generation method which may be implemented in conjunction with any one of the first to tenth aspects. In the eleventh aspect, the target (200) includes an image. This aspect contributes to improving the accuracy of classification based on a learned model (M11).

A twelfth aspect is a data generation method which may be implemented in conjunction with any one of the first to eleventh aspects. In the twelfth aspect, the data generation method further includes an adjustment step (S15) including removing learning data, of which the evaluation information fails to meet a standard, from the data (D14) for machine learning. This aspect contributes to improving the accuracy of classification based on a learned model (M11).

A thirteenth aspect is a decision method, which includes executing a classification of the target (200) using a learned model (M11). The learned model (M11) has been generated by machine learning using the learning data of the data (D14) for machine learning that has been generated by the data generation method according to any one of the first to twelfth aspects. This aspect contributes to improving the accuracy of classification based on a learned model (M11).

A fourteenth aspect is a program, which is designed to cause one or more processors to perform the data generation method according to any one of the first to twelfth aspects. This aspect contributes to improving the accuracy of classification based on a learned model (M11).

A fifteenth aspect is a program, which is designed to cause one or more processors to perform the decision method according to the thirteenth aspect. This aspect contributes to improving the accuracy of classification based on a learned model (M11).

A sixteenth aspect is a data generation system (10), which includes a first acquirer (151), a second acquirer (152), and a generator (154). The first acquirer (151) acquires result information (D11) about a result of a classification executed by a living being (300) on a target (200). The second acquirer (152) acquires execution information (D12) about execution of the classification. The generator (154) generates data (D14) for machine learning based on the result information (D11) and the execution information (D12). The data (D14) for machine learning includes learning data and evaluation information about evaluation of the learning data. This aspect contributes to improving the accuracy of classification based on a learned model (M11).

Note that the second to twelfth aspects are also applicable in an appropriately modified form to the sixteenth aspect.

### REFERENCE SIGNS LIST

10 Data Generation System
151 First Acquirer
152 Second Acquirer
154 Generator
200 Target
300 Living Being
D11 Result Information
D12 Execution Information
D13 Target Information
D14 Data for Machine Learning
M11 Learned Model
S11 First Acquisition Step
S12 Second Acquisition Step
S14 Generation Step
S15 Adjustment Step

1. A data generation method comprising:
a first acquisition step including acquiring result information about a result of a classification executed by a living being on a target;
a second acquisition step including acquiring execution information about execution of the classification; and
a generation step including generating data for machine learning based on the result information and the execution information, the data for machine learning including learning data and evaluation information about evaluation of the learning data.

2. The data generation method of claim 1, wherein
the evaluation information includes an evaluation value indicating a degree of accuracy of the learning data.

3. The data generation method of claim 1, wherein
the learning data is data representing correspondence between target information about the target and the result information.

4. The data generation method of claim 1, wherein
the learning data includes supervisor data.

5. The data generation method of claim 1, wherein
the execution information includes time information about a time it has taken for the living being to have the classification done.

6. The data generation method of claim 1, wherein
the execution information includes condition information about a condition of the living being.

7. The data generation method of claim 6, wherein
the condition of the living being includes at least one of mental and physical conditions of the living being.

8. The data generation method of claim 1, wherein
the result information includes results of classifications executed by a plurality of the living beings, and
the execution information includes relative information about the respective classifications executed by the plurality of the living beings.

9. The data generation method of claim 1, wherein
the execution information includes statistical information about statistics of the results of classifications executed by a plurality of the living beings on the target.

10. The data generation method of claim 1, wherein
the execution information includes subjective information about a subjective opinion of the living being on the classification.

11. The data generation method of claim 1, wherein
the target includes an image.

12. The data generation method of claim 1, further comprising an adjustment step including removing learning data, of which the evaluation information fails to meet a standard, from the data for machine learning.

13. A decision method comprising executing a classification of the target using a learned model, the learned model having been generated by machine learning using the learning data of the data for machine learning that has been generated by the data generation method of claim 1.

14. A non-transitory computer-readable tangible recording medium storing a program designed to cause one or more processors to perform the data generation method of claim 1.

15. A non-transitory computer-readable tangible recording medium storing a program designed to cause one or more processors to perform the decision method of claim 13.

16. A data generation system comprising:
a first acquirer configured to acquire result information about a result of a classification executed by a living being on a target;
a second acquirer configured to acquire execution information about execution of the classification; and
a generator configured to generate data for machine learning based on the result information and the execution information, the data for machine learning including learning data and evaluation information about evaluation of the learning data.
